(19) United States
(12) Patent Application Publication
(10) Pub. No.: US 2010/0182123 A1
(43) Pub. Date: Jul. 22, 2010

(54) SYSTEM FOR MONITORING USERS' TIME AND ATTENDANCE AND CONTROLLING USERS' ACCESS

(75) Inventor: Michael Alan Press, Milton Keynes (GB)

Correspondence Address: LUEDEKA, NEELY & GRAHAM, P.C., P O BOX 1871, KNOXVILLE, TN, 37901, US

(73) Assignee: ALUFIX CONTRACTS LIMITED, Belfast (IE)

(21) Appl. No.: 12/396,915

(22) Filed: Mar. 3, 2009

(30) Foreign Application Priority Data
Jan. 21, 2009 (GB) 0900988.7

(51) Int. Cl. G08C 19/00; G08B 29/00; G06F 7/04

(52) U.S. Cl. 340/5.28; 340/5.7; 340/5.82

(57) ABSTRACT

Systems and method, remotely monitor; the times, at which a user or users access certain facilities. Particularly, but not exclusively such systems can be used to monitor, at a central location, an employee's working times, at remote locations, for example building sites. The use of biomettic scanners in such systems can allow users' attendance to be monitored remotely without the need for supervision.

### CROSS-REFERENCE TO RELATED APPLICATION

This application claims priority under all applicable rules and statutes to United Kingdom patent application number GB 0900988.7, filed 21 Jan. 2009, the entire contents of which is incorporated herein by reference.

### FIELD

The present invention relates to systems and methods for remotely monitoring the times at which a user or users access certain facilities. Particularly, but not exclusively, such systems can be used to monitor, at a central location, employee's working times at remote locations, for example building sites. The use of biometric scanners in such systems can allow users' attendance to be monitored remotely without the need for supervision.

### BACKGROUND

Systems are known for monitoring the times at which employees clock in and out of their places of employment Systems in which employees clock in and clock out using biometric devices at locations remote from the location at which such data is recorded are also known.

### SUMMARY

According to a first aspect of the present invention, there is provided a system for monitoring a user's or users' access at a first location to a facility at a second location remote there from.

According to a second aspect of the present invention, mere is provided system for controlling users' access at a first location to one or more facilities at a second location remote there from.

According to a third aspect of the present invention, there is provided a method of monitoring, at a central terminal, a user's or users' access to a facility at a remote terminal remote there from.

### BRIEF DESCRIPTION OF THE DRAWINGS

The present invention will now be described, by way of example only, with reference to the accompanying drawings, in which:

FIG. 1 shows a schematic representation of a first embodiment of a system in accordance with the present invention; and

FIG. 2 shows a method carried out by a second embodiment of a system in accordance with the present invention.

### DETAILED DESCRIPTION

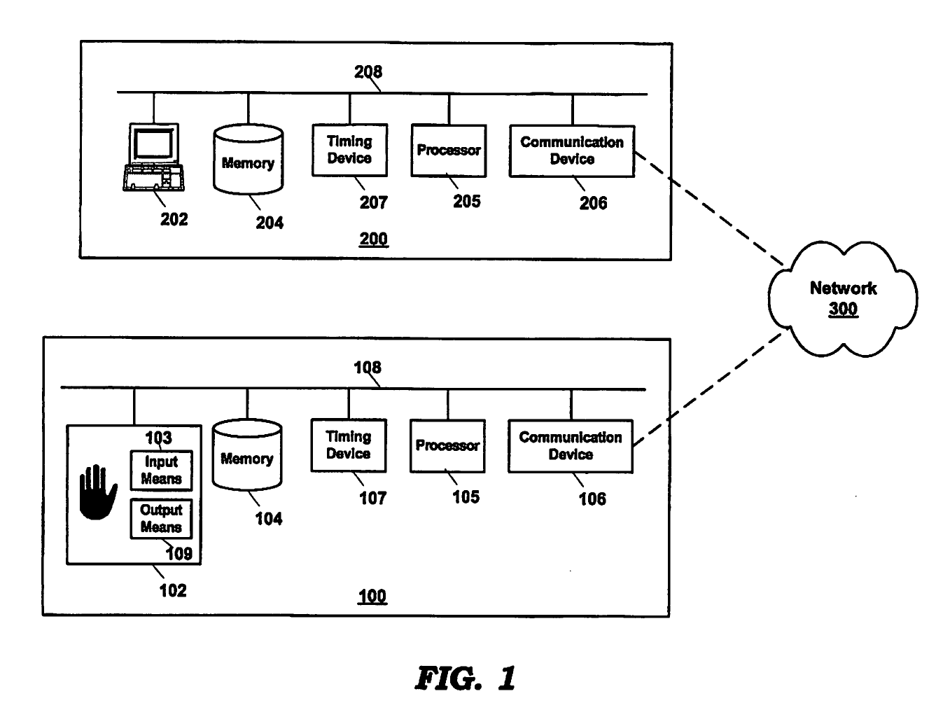

As can be seen in FIG. 1, a first embodiment of a system in accordance with the present invention, comprises two terminals 100, 200, which can communicate with each other via a network 300.

One of the terminals is a central terminal 200, which is located at a location where the organisation wishes to maintain records of employees' working hours.

The other terminal is a remote terminal 100, which is located at a location where the attendance of employees is to be monitored. The remote terminal 100 does not have to be located at a fixed location. Optionally, the remote terminal may be located in a vehicle.

In the first embodiment, the system is used to monitor the times at which employees of an organisation commence and finish their working day at locations remote from that of central terminal 200.

Although the first embodiment is depicted as having a single remote terminal 100, it is possible for any number of equivalent remote terminals to be provided, all of which may communicate with the central terminal 200 via a network 300 or be connected directly thereto.

Remote terminal 100 comprises a biometric scanner 102, a memory 104, a processor 105, a communication device 106, and a timing means 107.

The biometric scanner 102 of the first embodiment is a hand scanner, but could be another type of scanner capable of capturing a different biometric representative of an individual, such as a biometric based upon the individual's iris, face, fingerprint, or ear shape.

The biometric scanner 102 may be used for recognition, whereby the system determines the identity of the user from whom a biometric has been captured. This is done by comparing the captured biometric with a plurality of stored biometric templates each of which are representative of a respective user's identity.

Alternatively, the biometric scanner 102 may be used for verification, whereby the user claims an identity corresponding to a stored biometric template which is compared with the biometric captured from the user to determine if they match. In a verification scenario, the biometric scanner 102 comprises input means 103 (for example, a number key pad) by which a user may input a code representative of their identity.

For the purpose of the present disclosure, the term identification is intended to encompass both verification and recognition. The first embodiment is described with respect to a verification scenario. However, h would be within the abilities of the person skilled in the art to modify the first embodiment to operate in a recognition scenario.

The biometric scanner 102 is configured to generate the user's biometric, which can then be communicated to the other components via a communication means 108.

The biometric scanner comprises an output means 109 which may indicate to the user that a successful or unsuccessful access attempt (that is, it may indicate that the user's identity has or has not been recognised/verified).

Memory 104 is configured to store biometric data from the biometric scanner 102, biometric templates with which to compare the biometric data, time data from the timing means 107, and identity data representative of the identity of one or more users. In addition, memory 104 can store other information which may be required, such as timetable data representing the times that employees are expected/allowed to work.

Communication device 106 is configured and arranged to transmit or receive data via the network 300 to the communications device 206 of the central terminal. In the first embodiment, communication device 106 is configured to transmit data via the General Packet Radio Service (GPRS).

The communication device 106 does not maintain a permanent communications link with the communication device 206, but can be configured to periodically send and receive transmissions or to send and receive transmissions as and when required.

Timing means 107 provides time data. This can be done either by an internal clock, or by receiving time data via communication device 106.

Processor 105 carries out any data processing tasks and controls the other components of the remote terminal 100. For example, processor 105 is used to verify the identity of an individual by comparing the biometric received from biometric scanner 102 with a biometric template stored in memory 104, to thereby determine whether they match.

Central terminal 200 comprises a user interface 202, a memory 204, a communication device 206 a timing device 207 and a processor 205.

In the present embodiment user interface 202 is a standard personal computer. Personal computer 202 can be used to access all data stored in memory 204.

Memory 204 and timing means 207 are substantially the same as memory 104 and timing means 107.

Memory 204 may store additional information, such as data relating to which users are employed to work at each remote location.

Communication device 206 is similar to communication device 106, but may be used to communicate with multiple remote terminals 100.

Processor 205 is similar to processor 105, but is not used to verify or recognise users' biometrics.

The components of central terminal 200 interact via communication means 208.

When a user at the remote location uses the remote terminal 100, the biometric scanner 102 captures biometric data representative of the user's identity and receives an input code from the user corresponding to a claimed identity via input means 103. The biometric data and claimed identity data are provided via communication means 108 to the processor 105. The processor 105 instructs die memory 104 to provide the biometric template corresponding to the claimed identity. The biometric template and captured biometric data are then compared using known algorithms by the processor to determine if they match.

In the first embodiment, this comparison is carried out by using known methods to produce a similarity score (such scores are well known in the art, e.g. Euclidian distance or mahalanobis distance), representative of the difference between the biometric template and the captured biometric data. This score is compared with a matching threshold to establish whether there is a match. This matching threshold is specific to the client and therefore is stored and communicated along with the biometric template.

If the processor determines mat there is a match (that is, that the captured biometric data corresponds with the same user as the stored biometric template), then it instructs the memory 104 to record that the individual scanned their hand at that time. The current time is provided by the timing device 107.

If the processor determines that there is not a match, then it instructs the memory 104 to record that there was a failed attempt to claim mat identity at that time.

Consequently, the remote terminal 100 can operate as an independent unit (that is, independently of the central terminal 200) to record the times at which various users use the hand scanner.

Advantageously, the remote terminal 100 may be provided with an external interface (not shown) through which the remote terminal 100 may interface with other devices. Such devices may include electronic door locks, vehicle security devices, or power supplies for computer terminals. For example, when a user's identity is verified, an electronic door lock may be unlocked for a pre-defined time period. Accordingly, the remote terminal 100 may be programmed to prevent unauthorised access to particular facilities, such as rooms of a building, vehicles, or particular computer functionality;

Central terminal 200 is able to communicate with remote terminal 100 via the communication devices 106, 206 and the network 300.

When the communication device 106 of the remote terminal 100 attempts to communicate with the communication device 206 of the central terminal 200, it first attempts to create a communications channel. If the network 300 is unreliable, then this may not be possible. However, the system must be able to continue to operate successfully even when communication between central terminal 200 and remote terminal 100 is not possible.

In this embodiment, the remote terminal 100 is provided with an additional communication means such as a short message service (SMS) communication device. When the system establishes mat communication is not possible, the remote terminal 100 sends a message reporting the problem. This message may be sent to the central terminal 200 (which may also comprise a short message service (SMS) communication device) or directly to an engineer.

In the first embodiment, the remote terminal 100 stores in memory 104 all the times at which users successfully or unsuccessfully operated the hand scanner 102. During normal operation, the remote terminal 100 periodically establishes whether communication with the central terminal is possible. This is done by sending a short message and receiving a short reply. If communication is possible, then the remote terminal 100 transmits all of the new recorded data (that is, data not previously transmitted) to the central terminal 200.

Optionally, the central terminal can transmit a check signal back to the remote terminal 100 to confirm that the data has been received. Such a check signal could, for example, be the amount of data transferred. Then, once receipt is confirmed, remote terminal 100 can delete the sent data or simply allow it to be overwritten. Alternatively, the sent data can be deleted a period of time after it is sent, or only when more memory capacity is required.

If communication is not possible, the remote terminal 100 can continue to operate independently, by storing the new recorded data in memory 104 to be transmitted at a later time (the next period).

The benefit of transmitting data periodically is that the time of communication can be determined so as to coincide with periods where the network is least busy or when associated charges for using the network are lowest.

When a new individual is presented to the system, they must be enrolled. The process of enrolment generates a biometric template of the user and calculates the relevant client specific matching threshold. When initialised, the biometric scanner automatically adjusts its sensitive to compensate for environmental conditions, such as ambient illumination.

This is done by operating the biometric scanner one or more times to capture biometric data, which is then processed by processor 105 to generate a biometric template. The input means 103 is operated to input an input code representative of the user's identity. The biometric template and input code are stored in memory 104, and may be associated with time data provided by timing means 107 to thereby record the time at which the user was enrolled.

The client specific threshold may be determined using known methods (such as using training data captured in advance to determine the threshold that corresponds to the equal error rate), or may be initialised at a default value for all clients. If a default value is used, the threshold may be individually altered for each individual manually, or in response to many failed verification attempts, as will be described below.

The enrolment process set out above is sufficient to enrol a user at a single remote terminal 100, but in systems having multiple remote terminals, it may be desirable to provide die biometric template to all or a subset of the remote terminals, so mat the user may verify their identity using the hand scanner of each of the subset of remote terminals.

To manage such a system, central terminal 200 stores in memory 204 the biometric templates and associated time and identity data of every user enrolled in the system by each remote terminal.

If a user has been enrolled using remote terminal 100 since the time at which recorded data was last transmitted from remote terminal 100 to the central terminal 200, then the next time that recorded data is transmitted to central terminal 200, the biometric template, along with the input code and time data are also transmitted to central terminal 200. Therefore, database of biometric templates at the central terminal 200 is updated.

In the first embodiment, each remote terminal 100 stores only the biometric templates (and associated matching thresholds) for users who are currently employed to work at that location.

A record of which user is expected/allowed to work at each location is maintained by die central terminal 200. Therefore, central terminal 200 will ensure that the memory 104 of each remote terminal 100 stores the most recently updated biometric template for each individual expected to work at that location. If a biometric template is updated at one remote terminal, and the user is expected to work at another remote terminal, then the next time central terminal 200 and the other remote terminal communicate, the biometric template, along with die input code and time data are transmitted to the remote terminal. Similarly, if the remote terminal 100 does not store a biometric template for a user who is expected to work at the corresponding location, then it will be transmitted.

Conversely, the central terminal 200 instructs the remote terminal 100 to delete the biometric template of users who are not expected/permitted to work at that location. Thus, the central terminal 200 can be used to control remotely who is authorised to attend workplaces at a variety of different remote locations, by controlling which templates are stored locally and also by controlling the days and the hours within the days for which the biometric templates are valid.

As stated above, the data is transmitted periodically, for example, weekly. If a biometric template is already stored in the memory of the remote terminal 100, the central terminal 200 does not transmit it, unless it has subsequently been updated at a different remote terminal. If between subsequent periods, the timetable of who should be working at each remote terminal remains unchanged, transmission of biometric templates is unnecessary.

Advantageously, the system thereby minimises the volume of data transmitted.

For example, in an office building, all employees would have permission to use the main doors to access the building, but within the building, each employee may only have access to their own office. Optionally, a manager may have access to all offices.

Each remote terminal 100 is therefore associated with one or more facilities, for controlling access thereto. Users who have access to a particular facility will have a biometric template stored on the associated remote terminal 100. Users who do not have access to a particular facility will have no biometric template stored on the associated remote terminal 100. Since the central terminal 200 determines what biometric templates 100 are stored on each remote terminal 100, the system provides for central control of access to each facility.

Moreover, it is possible to determine what periods of time a user has access to each facility.

For example, a person may be scheduled to use a vehicle between 9:00 a.m. and 6:00 p.m., in which case the remote terminal 100 associated with the vehicle will only allow access to the vehicle within that period of time. The system allows central control of a plurality of geographically distant locations.

The central terminal 200 stores a record of which users have been granted access to each facility and for what periods of time such access is granted. Once this data has been inputted into the central terminal 200, these records are transmitted to the remote terminals 100 to thereby allow access only at those times.

Any attempts to gain access outside of the user's allowed times then memory 104 is instructed to record the identity claimed, whether the identity was verified and at what time the claim was made. These records are subsequently communicated to the central terminal 200 as described above.

Biometric data captured by die biometric scanner 102 is not necessarily consistently the same every time a user's biometric is scanned. With hand biometrics, this variation can be caused by a number of factors, e.g. the alignment of the user's hand on the scanner may differ between scans, the user's hand may vary in size throughout the day or depending on hydration levels. Also, the user's hand may change with time, thus necessitating an update of the corresponding biometric template.

Each biometric template is a representation of the data captured from the hand of the user. It is possible for the biometric template to “overfit” the captured data. This means that the biometric template is not robust to the above-mentioned variations. For example, if the user's hand biometric was enrolled with a particular alignment, then the scanner may only correctly verify the user's identity when their hand is scanned with a similar alignment Furthermore, in some circumstances, the user's biometric template may only function well on a single machine. For example, if the biometric template incorporated some information about the scanner (perhaps by capturing in the scan a mark on the scanner).

A biometric template is said to “generalise” well, when it is robust to variations in captured biometric data, whilst being representative of a single individual.

In the first embodiment the central terminal 200 stores the records of successful and unsuccessful verification attempts made by each user, and the times thereof. These records are used to determine how well a particular stored biometric template performs.

The records can be used to indicate when a user's biometric template may need updating.

If a user makes several unsuccessful attempts to verify their identity using a biometric scanner 102, but then makes a successful attempt, this may be indicative of the user's biometric performing badly. The memory 204 of the central terminal 200 stores data relating to successful attempt and unsuccessful attempts. The processor 205 can establish whether an attempt was a “false rejection” if, within a predetermined period of time, several unsuccessful attempts are followed by a successful attempt

The predetermined period of time would be short to thereby only included repeated attempts to verify the user's identity on a single occasion.

The processor 205 can then calculate the ratio of false rejections to the number of total access attempts, to thereby determine a false rejection rate.

The false rejection rate can be compared with a predetermined false rejection rate threshold to determine if the user's biometric needs to be re-enrolled.

When the processor 205 of the central terminal 200 determines mat a biometric needs to be re-enrolled, the central terminal 200 via communication device 206 instructs the remote terminal 100 via communication device 106 to inform the user that re-enrolment is necessary. This is done using output means 109, the next time that the user successfully operates the hand scanner 102.

Alternatively, when the false rejection rate is slightly higher than expected, but not high enough to indicate that the biometric template needs updating, it is possible to slightly modify the client specific matching threshold to thereby reduce the false rejection rate. This can be done by incrementing it or decrementing it by a small predetermined value.

The system allows central control of the threshold conditions at a plurality of geographically distant locations.

In alternative embodiments this process may be carried out by the remote terminal 100, in which case the memory 104 of the remote terminal 100 can store the data relating to successful attempt and unsuccessful attempts and the processor 105 of the remote terminal can be used to establish the false rejection rates.

Optionally, communication devices 106, 206 can additionally communicate via the Short Message Service (SMS) to pass simple instructions such as “reboot” from the central terminal 200 to the remote terminal 100 or to pass error messages from the remote terminal 100 to the central terminal 200. Also, the remote terminal may be configured to communicate with a phone network and reboot when a “voice” call is received.

Such redundant communications paths may be used to transmit simple instructions to remote terminal 100 when the primary communication method (GPRS) fails.

The following describes a second embodiment of a system in accordance with the present invention. In all but the following respects, the second embodiment is substantially the same as the first embodiment

In the second embodiment, instead of periodically transmitting data, during normal operation, the remote terminal 100 may attempt to communicate with central terminal 200 immediately in response to an event, such as a user operating the hand scanner 102. If communication is possible, then such a method can provide near real-time communication with the central terminal 200.

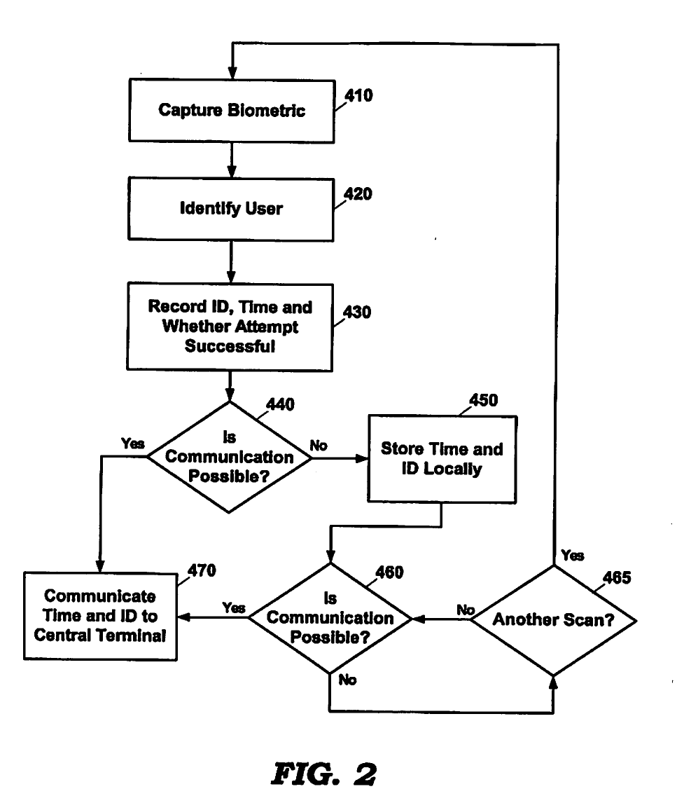

The procedure carried out by the remote terminal is depicted in FIG. 2.

At step 410, a user operates the biometric scanner 102 to thereby input captured biometric data into remote terminal 100.

At step 420, the processor 105 carries out identification of the user. The processor 105 determines which stored biometric template the captured biometric data corresponds to and thereby establishes the identity of the user, from whom the biometric data was captured, as being that which corresponds to the stored biometric template.

At step 430, the processor 105 records the identity of the user (this is stored only when identification is successful—in a verification scenario, the claimed identity may be stored), along with the time at which the biometric data was captured and whether or not the identification attempt was successful. Also at step 430, the output means 109 can indicate whether or not the identification attempt was successful to the user.

At step 440, the processor 105 instructs communication means 106 to determine if communication with communication means 206 of central terminal 200 via network 300 is possible.

If communication between remote terminal 100 and central terminal 200 is possible, then the system progresses to step 470.

If communication between remote terminal 100 and central terminal 200 is not possible, then the system progresses to step 450.

At step 450, the memory 104 of the remote terminal 100 stores the recorded data.

At step 460 the processor 105 periodically instructs the communication device 106 to determine if communication is possible. This can be carried out at a high rate to thereby ensure that data can be transmitted soon after communication becomes possible. Once communication between remote terminal 100 and central terminal 200 becomes possible, then the system progresses to step 470.

Advantageously, at step 465, the remote terminal 100 can continue to operate independently. That is, if the biometric scanner 102 is operated again whilst the remote terminal 100 is attempting to establish communication with the central terminal 200, then the system may return to step 410.

At step 470, the system transmits all recorded data that has not yet been transmitted to the central terminal 200.

In the first embodiment, each remote terminal 100 stores only the biometric templates for users who are currently employed to work at that location. In alternative embodiments, each remote terminal may store the entire database of biometric templates and matching thresholds. Optionally, in this case, each remote terminal 100 can store an indication of which users are expected at that location.

It is possible for the remote terminal 100 to incorporate a GPS device in order to enable monitoring not only of the time at which a user operates the biometric scanner 102, but also the location of the remote terminal 100 as the scanner is being operated. In such a device, the location of the remote terminal 100, at the time at which die biometric data was captured by the biometric scanner 102, would be stored and transmitted with the corresponding time and identity data. Advantageously, such a remote terminal 100 could be fully portable, and for example, could be located in a vehicle.

As described above with respect to time data, the central terminal 200 is operable to restrict the locations for which access is permitted. The central terminal 200 stores a record of which users can use remote terminal 100 and at what locations. The central terminal 200 transmits these records to the remote terminals 100 to thereby allow the hand scanner 102 to be used only at specific locations.

The central terminal 200 transmits these records to the remote terminals 100 either as they are entered or periodically (e.g., nightly).

Such an embodiment would not only ensure that employees accessed the device at the correct time, but also at the correct location, thereby ensuring that employees are recorded as working at a particular location, at a particular time.

In contrast to the first embodiment, in which the biometric template is re-enrolled, in the third embodiment of the present invention, the biometric template may be updated over a period of time by the following method.

The client specific threshold is modified by a large pre-determined amount (larger than the small pre-determined amount of the first embodiment) such that only a small similarity between the stored biometric template and the captured biometric data is required for a successful verification. This large pre-determined amount may be sufficient to increase the acceptance rate by a pre-determined amount, e.g. 20%. Over a predetermined number of subsequent scans, the captured biometric data can be stored so that after the pre-determined number of scans, the stored data is processed (either alone, or with the existing biometric template) by the processor 105 to thereby produce a new biometric template. When the new biometric template has been created, the client specific threshold can be reset to its previous value.

In other words, after the remote terminal 100 or the central terminal 200 determines that the template needs to be updated, the subsequent successful access attempts are used as enrolment data to generate a new biometric template.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A system for monitoring a user's or users* access at a first location to a facility at a second location remote therefrom, comprising:
a central terminal located at the first location, comprising:
a central terminal memory, arranged to store biometric templates for each user enrolled in the system, and time and identity data; and
a central terminal communication device for transmitting and receiving data;
a plurality of remote terminals each comprising:
a remote terminal memory, arranged to store at least one biometric template and time data;
a remote terminal communication device for transmitting and receiving data;
a biometric input device for measuring a biometric of a user; and
a remote terminal processor for comparing a measured biometric with a stored biometric template to thereby identify a user and for generating a biometric template from at least one biometric provided by the biometric input device;
a network via which the central terminal and the remote terminal can communicate, wherein:
each remote terminal is configured and arranged to operate in at least a first mode, in which when a user activates a first function of the remote terminal:
the biometric input device measures a biometric of the user,
the remote terminal processor identifies the user, by comparing the measured biometric with the stored biometric template corresponding to that user;
the remote terminal communication device transmits to the central communication device time and identity data, corresponding to the identity of the user and the time at which the biometric input device measured the user's biometric; and
the central terminal memory stores the time and identity data

2. A system according to claim 1, wherein each remote terminal is configured and arranged to also operate in a second mode, in which:
when a user activates a first function of the remote terminal:
die biometric input device measures a biometric of the user;
the remote terminal processor identifies the user, by comparing the measured biometric with the stored biometric template corresponding to that user; and
the remote terminal memory stores the time and identity data;
at predetermined times when communication is possible between the remote terminal communication device and the central terminal communication device:
the remote terminal communication device transmits to the central communication device the time and identity data stored in the remote terminal memory; and
the central terminal memory stores the time and identity data.

3. A system according to claim 1 wherein the remote terminal is located at the second location.

4. A system according to claim 1 wherein:
the remote terminal comprises location determination means for determining the location of the remote terminal at the time at which the biometric input device measured the user's biometric, and generating location data corresponding thereto;
when the remote terminal memory stores the time and identity data, the remote terminal also stores corresponding location data; and
when the remote terminal communication device transmits to the central communication device time and identity data, corresponding to the identity of the user and the time at which the biometric input device measured the user's biometric, die remote terminal communication device also transmits to die central communication device corresponding location data.

5. A system according to claim 4, wherein the location determination means is a GPS device.

6. A system according to claim 1 wherein the remote terminal and the central terminal communicate via GPRS.

7. A system according to claim 1 wherein the central terminal periodically:
instructs the remote terminal to delete any biometric templates corresponding to users no longer permitted to work at the second location; and
transmits to the remote terminal biometric templates corresponding to users that are permitted to work at the second location, for which no biometric template is already stored.

8. A system according to claim 1 wherein the central terminal periodically transmits to the remote terminal updated biometric templates corresponding to users that are permitted to work at the second location, for which older biometric templates have been previously stored.

9. A system according to claim 1 wherein the remote terminal processor when comparing a measured biometric with a stored biometric template to thereby identify a user
generates a similarity score representative of the similarity of the measured biometric and the stored biometric template; and
compares the similarity score with a client specific threshold.

10. A system according to claim 1 wherein:
the central terminal stores, for each user, access time data recording the periods of time that the user is permitted to access the facility, and communicates, to each remote terminal the time data for only the users who are permitted to use the facility corresponding therewith; and
each remote terminal validates access to a facility only to the users for which biometric templates are stored at the remote terminal, and only for the periods of time corresponding to the access time data.

11. A system according to claim 10 wherein each remote terminal comprises access control means for controlling opening and closing of one or more entrances to the facility relating thereto and each remote terminal opens the entrance(s) to a user only for the periods of time corresponding to the access time data.

12. A system for controlling users' access at a first location to one or more facilities at a second location remote there from, comprising:
a central terminal located at the first location; and
at least one remote terminal located at the second location, wherein:
the central terminal stores biometric templates for all users of the system and controls which biometric templates are stored at each remote terminal;
the central terminal stores, for each user, access time data recording the periods of time that the user is permitted to access the facility, and communicates, to each remote terminal, the time data for only the users who are permitted to use the facility corresponding therewith; and
each remote terminal validates access to a facility only to the users for which biometric templates are stored at the remote terminal, and only for the periods of time corresponding to the access time data.

13. A system according to claim 12 wherein:
the central terminal periodically instructs each remote terminal to delete biometric templates corresponding to users who are not permitted to use the facility corresponding thereto; and
the central terminal periodically transmits to each remote terminal biometric templates, that are not already stored in the memory of the respective remote terminal, which correspond to users who are permitted to use the facility corresponding thereto.

14. A system according to claim 12 comprising:
a plurality of remote terminals located at the second location, each configured and arranged to control access to a corresponding facility.

15. A method of monitoring, at a central terminal, a user's or users' access to a facility at a remote terminal remote there from, wherein:
the remote terminal carries out the steps of:
receiving a biometric representative of an individual's identity from a biometric input device;
verifying the individual's identity or determining the user's identity, using the received biometric; and
recording the time at which the biometric is received by the biometric device; and
if the remote terminal can communicate with the central terminal, then the remote terminal carries out the further steps of:
communicating the individual's identity and the recorded time via a communications network to the central terminal; and
if the remote terminal cannot communicate with the central terminal, then the remote terminal carries out the further step of:
storing the individual's identity and die recorded time; and
when communication between the remote terminal and central terminal becomes possible, then communicating the stored individual's identity and the stored recorded time via a communications network to the central terminal.
